(19) United States
(12) Patent Application Publication
(10) Pub. No.: US 2010/0119336 A1
(43) Pub. Date: May 13, 2010

(54) AUTOMATIC SYSTEM FOR CONSTRUCTION OF BUILDINGS

(75) Inventor: Virgilio Echauri Senosiain, Pamplona (ES)

Correspondence Address: THE NATH LAW GROUP, 112 South West Street, Alexandria, VA, 22314, US

(73) Assignee: Navarra Intelligent Concrete System S L, Pamplona (ES)

(21) Appl. No.: 12/451,708

(22) PCT Filed: May 29, 2008
(86) PCT No.: PCT/ES2008/000380

§ 371 Date: Dec. 16, 2009

(30) Foreign Application Priority Data
May 29, 2007 (ES) P200701466

(51) Int. Cl. E04G 21/16; B66C 17/00

(52) U.S. Cl. 414/10

(57) ABSTRACT

The invention relates to an automatic system for the construction of buildings, which uses a supporting structure (1) mounted on displacement rails (2), covering a space holding the building to be made, the construction taking place floor by floor, in such a way that all the parts of the construction are made in the installation itself, thereby defining a rigidly secured constructive assembly, based on reinforced concrete, in the building of each floor; for this purpose a number of platforms (4, 5) move in vertical displacement mode on the supporting structure (1), on which the construction operations are performed at the level of each floor, and include stores (3) in which the elements used for the construction are held, with a gantry crane (10) in the upper part for moving the construction elements.

### FIELD OF THE ART

The present invention relates to the construction of apartment buildings, proposing an automated system for construction which speeds up the construction process, with an important reduction of the time and labor necessary, based on structural and building concepts different from conventional concepts.

### STATE OF THE ART

In the construction of apartment buildings today, a system of reinforced concrete columns and beams is used, on which the platforms of the floors of different heights, also made of concrete, are carried out to then build with bricks, blocks or other elements, the exterior enclosing walls and the interior dividing partitions to define the openings or spaces of the apartments. In addition, the surfaces of the walls, partitions and ceilings must subsequently be coated with finishing plaster.

Said system for construction is essentially implemented manually, so it requires a great deal of labor, resulting in abundant occupational hazards, as the manufacturing times and costs are very high.

### OBJECT OF THE INVENTION

According to the invention, a system for construction is proposed which is carried out with automatic process means, based on a structural building with concepts different from those of conventional buildings, such that it can be carried out in an automated manner with more precise and higher quality results.

This system object of the invention is developed by means of a large-sized supporting structure which is movably mounted on displacement rails, said structure covering a space which goes beyond the dimensions of the building to be constructed, including platforms moving in vertical displacement mode, on which platforms the molding pieces for making double walls and floor platforms are lifted, whereas a gantry crane is incorporated in the upper part of the structure, which gantry crane can in turn be mounted to move in vertical displacement mode, and stores on the sides which can also move in vertical displacement mode.

The supporting structure consists of vertical poles in the lower part of which there are arranged pumps connected with pipes extending through the mentioned poles to impel the construction concrete to the necessary height.

Containers for concrete manufacturing materials are arranged in addition to the supporting structure, whereas the different elements to be used in construction are housed in the mobile stores, including thereamong particular formwork panels for building partitions.

Said formwork panels are structured in the form of large metal boxes with insulating material filler, including therein pneumatic screw spindles for the lashings in the application assembly, as well as a heat accumulation block for maintaining a suitable temperature (about 37° C.) for the concrete pouring for construction, and a vibrating mechanism to facilitate stripping.

These formwork panels are furthermore provided with mobile parts that can be extracted towards the front to act as male parts for building door or window openings in the concrete pouring for the construction of the application partitions.

The construction of a building on a previously prepared foundation is possible with such means, arranging the supporting structure on the construction site, such that the double walls for enclosing the contour of the building and the floor platforms for the different interior enclosures of the construction are constructed on site at the molding tables, said walls and platforms being carried by means of the gantry crane to their placement positions, the gantry crane itself then placing the formwork panels for the partitions on the floor platforms in the distribution corresponding with the partitioning of enclosures to be built, arranging the installations of electricity, plumbing installations, etc., between such formwork panels and then filling the openings with concrete.

A single construction of the entire distribution of spaces in each floor of the building is thus achieved, all made entirely of concrete, without bricks, arches, joists and other different elements that are used in conventional construction.

The operating process of this system of the invention can be carried out automatically with computer-controlled functional means, which considerably reduces the necessary labor and the risks of accidents, a much quicker and higher quality construction being achieved than with conventional manual operation.

The construction is done floor by floor, the functional means being displaced by the supporting structure to the height of the floor to be constructed in each case, such that during the construction of the exterior enclosure and partitions in a floor, other operations, such as the placement of doors and windows, covering of floors, and even furnishings, can be carried out in other lower floors, with the possibility that the lower floors are finished entirely during the construction of the upper floors, which in turn entails a huge reduction of the overall time for entire building.

Furthermore, considerable savings in terms of materials is obtained because the disposable wastes are considerably reduced, which also results in a savings in transport costs and the accumulation in dumps, with the subsequent environmental impact and contamination.

Therefore, the system of the invention has clearly advantageous features, acquiring its own identity and preferred character with respect to the conventional method for the construction of buildings.

### DESCRIPTION OF THE DRAWINGS

FIG. 1 shows a schematic perspective view of the supporting structure for the development of the system of the invention.

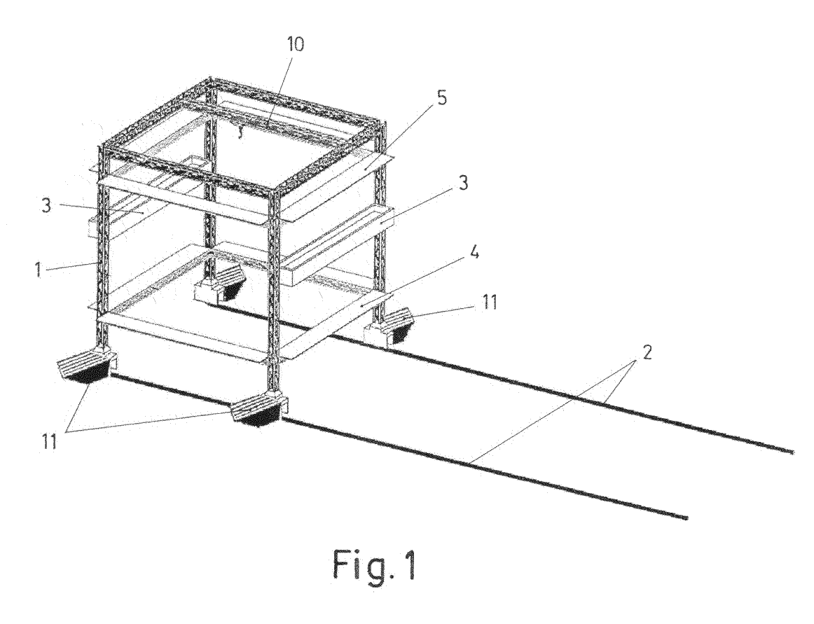

FIG. 2 is a schematic plan view of the structural operating assembly of said system of the invention, with the depiction of an apartment constructed inside it.

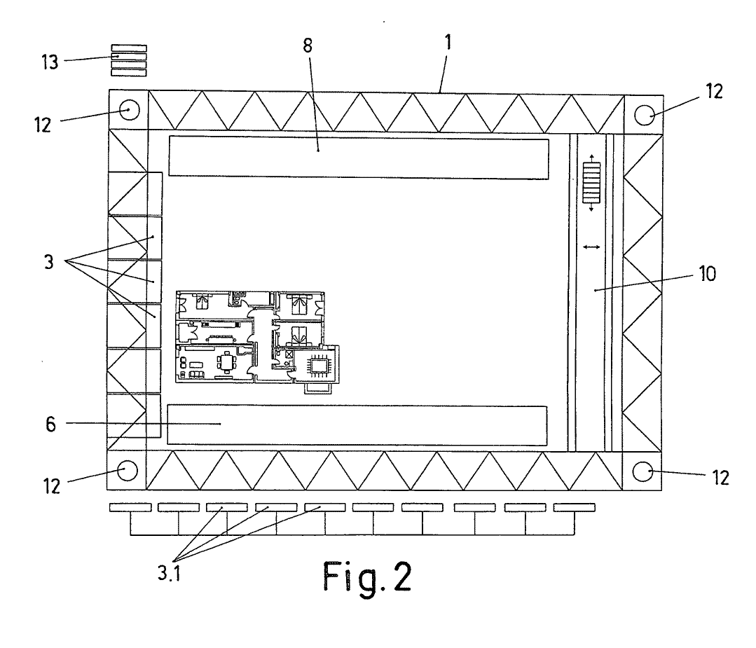

FIG. 3 is a plan view of the construction of the partitioning of an apartment according to the invention.

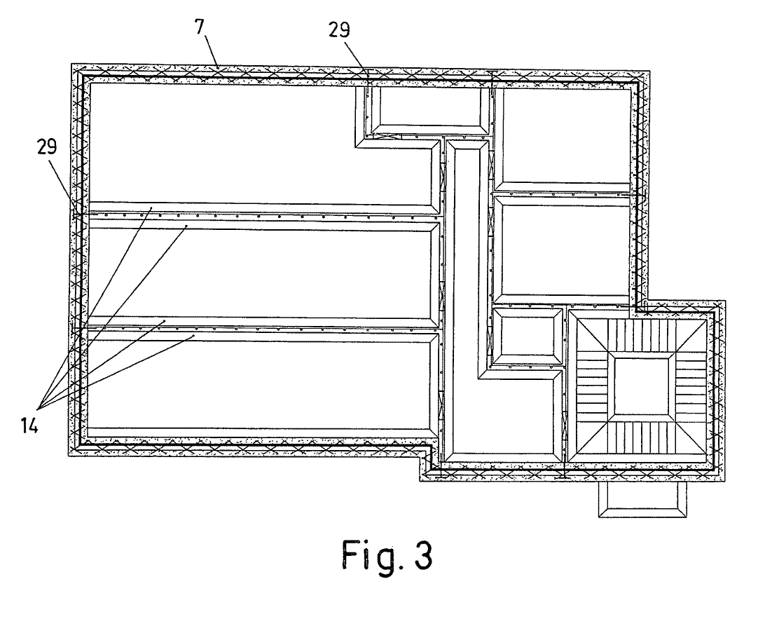

FIG. 4 is a perspective view of the structural form of an apartment constructed according to the invention.

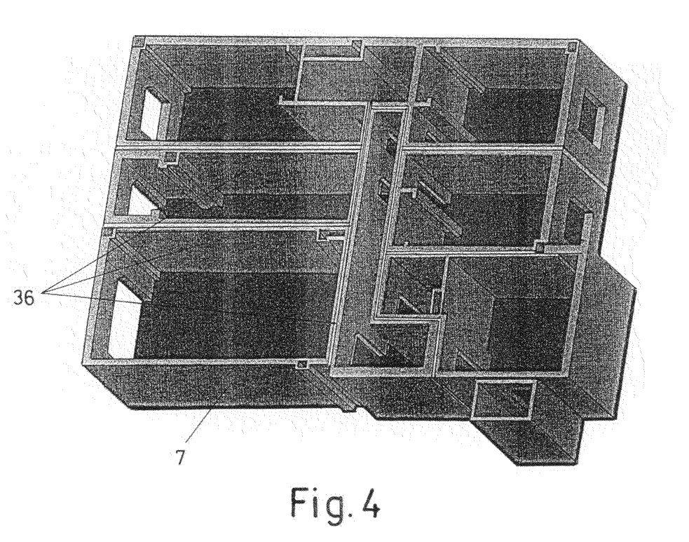

FIG. 5 is a section view of the construction of a double wall for the exterior enclosures according to the system of the invention.

FIG. 6 is a section view of a platform for building a floor according to said system of the invention.

FIG. 7 is a detail view of the connection between the partitions and the floor platforms in the construction of an apartment according to the invention.

FIG. 8 is a front view, without the front wall, of a formwork panel of the partitions.

FIGS. 9 and 10 are respective views of the upper part and of the lower part of the front formwork panel.

FIG. 11 is a view of the front face on which the formwork panel receives the concrete.

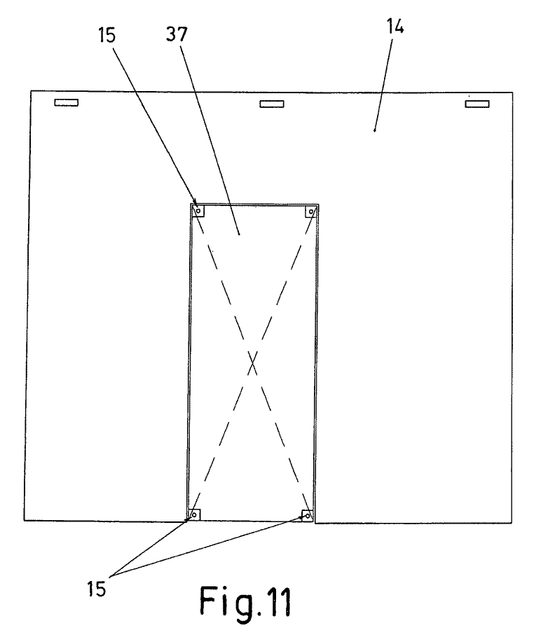

FIG. 12 is a profile view of two facing formwork panels, with their male parts connected to build a door opening.

FIG. 13 shows a vertical section of a construction example carried out according to the system of the invention.

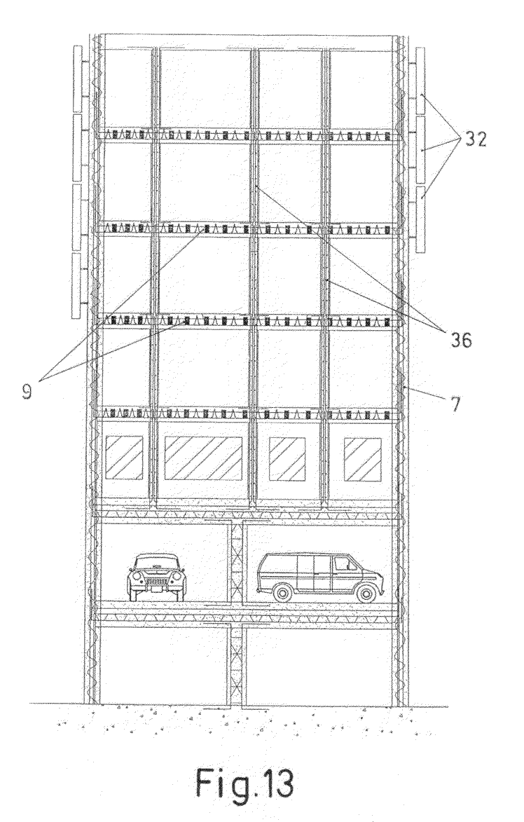

FIG. 14 is a schematic perspective view of an embodiment of the supporting structure with side protections in the upper contour.

### DETAILED DESCRIPTION OF THE INVENTION

The object of the invention relates to a system for construction which allows an automated and programmed process, supplying the necessary materials when they are to be applied, a construction with anti-earthquake and fireproof properties, and with suitable heat and acoustic insulation being achieved.

The system is developed according to a construction process which is carried out on a traditionally prepared foundation in the application site, arranging a large-sized supporting structure (1) resting on displacement rails (2) installed longitudinally on the sides of the space occupied by the building to be constructed.

Said supporting structure (1) has plan and height dimensions exceeding those of the building to be constructed, incorporating stores (3) moving in vertical displacement mode, in which elements necessary for the construction are housed, which elements are supplied from containers (3.1) located on the ground.

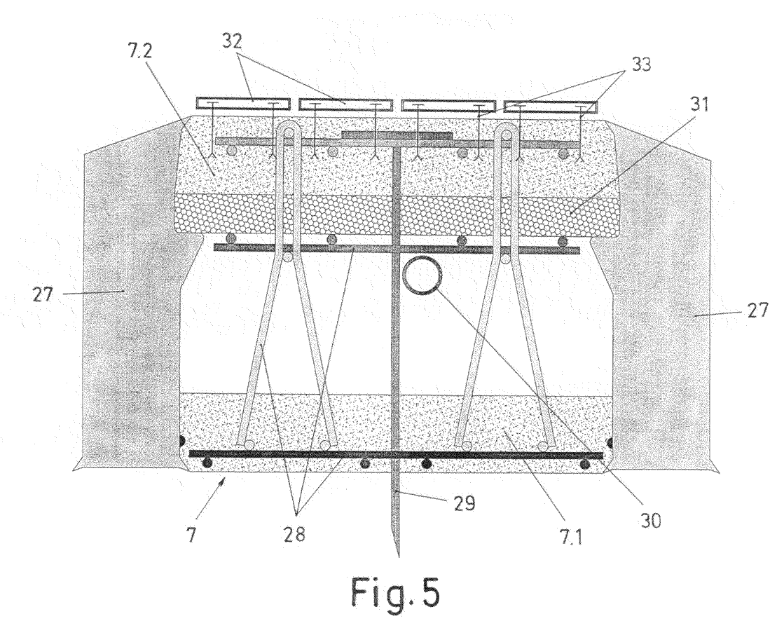

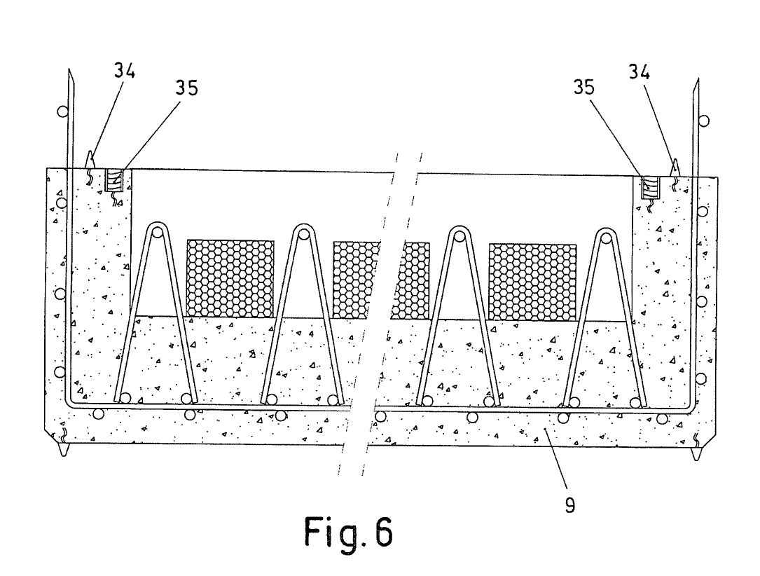

This supporting structure (1) furthermore includes platforms (4, 5) also moving in vertical displacement mode, there being arranged on the floor or in the lower platform (4) a table (6) for the molded building of double walls (7) as depicted in FIG. 5, and a table (8) for the molded building of floor platforms (9) as depicted in FIG. 6.

At the upper part of the mentioned supporting structure (1) there is arranged a gantry crane (10) which can be installed at a fixed height on the end of the supporting structure (1), or also moving in vertical displacement mode, for example by means of being supported on the mobile platform (5).

The supporting structure (1) is made up of several vertical poles with respect to which there are arranged in the lower part pumps (11) which allow impelling concrete through ducts (12) included in the mentioned poles of the supporting structure (1), for supplying said concrete for the application concrete pouring in the floors of the building to be constructed. In addition to the supporting structure (1), there are arranged aggregate stores (13) from which the materials for forming the concrete intended for the concrete pouring to be carried out are supplied.

All the elements necessary for carrying out the construction of a building according to the proposed system are housed in the stores (3) and platform (4) incorporated in the supporting structure (1) in a classified manner, formwork panels (14) intended for building the partitions of the apartments in the floors of the buildings to be constructed being provided.

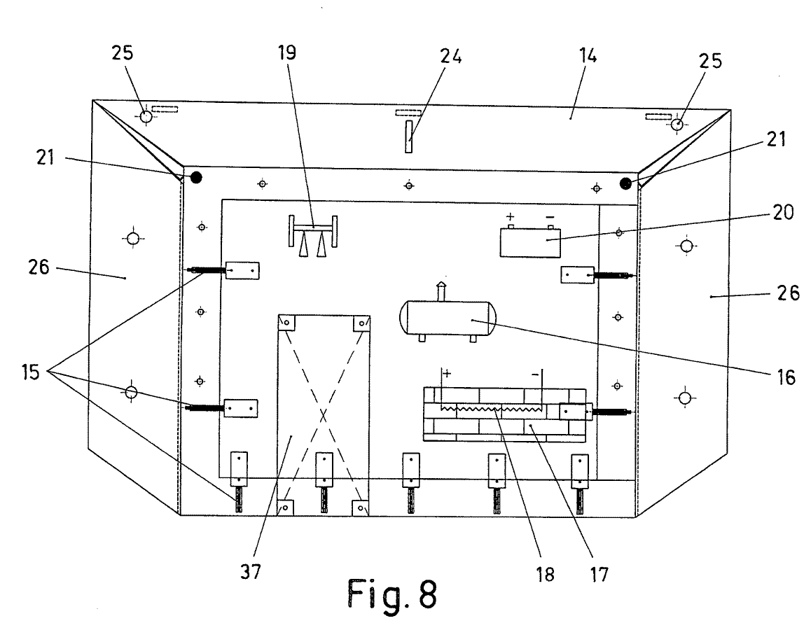

Each formwork panel (14) consists (FIG. 8) of a box-shaped metal structure with insulating material filler, a series of pneumatic screw spindles (15), intended for lashing the panel in application mounting being located therein, which screw spindles (15) are actuated by means of a compressor (16) which is also housed inside the respective panel (14).

A heat accumulation block (17) provided with a resistor (18), by means of which a temperature of the panel is maintained around 37° C., thus favoring the setting conditions of the concrete in the application formworks, is furthermore housed inside each panel (14).

A vibrating mechanism (19) is also included inside each panel (14), by means of which mechanism the release of the panel with respect to the concrete in the stripping is facilitated.

The electric powered functional elements installed in the equipment of each panel (14) are supplied from a battery (20) which is also housed inside the corresponding panel, connectors (21) being provided for the connection to photovoltaic electrodes or the grid for the purpose of recharging the battery (20) during the storage of the panel.

As can be observed in FIG. 10, the lower face of the panel (14) has holes (22) for the exit of the rods of the corresponding pneumatic screw spindles (15), and holes (23) intended for being fitted on positioning guides in the application assembly of the panel.

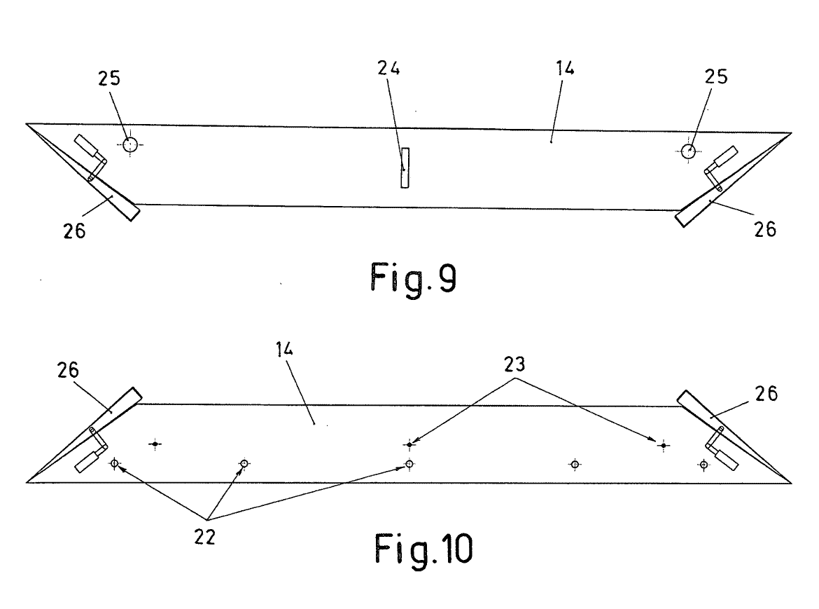

As can be observed in FIGS. 8 and 9, the upper face of the panel (14) has a central lashing (24) for the hoisting and movements thereof in its placement and removal with respect to the application mounting by means of the gantry crane (10) of the system, and lashings (25) displaced towards the ends for precise handling movements.

The panels (14) are complemented at the ends with padding (26) made of a synthetic material, such as polyurethane, through which the rods of the pneumatic screw spindles (15) of the ends of the panel (14) pass for the connection with other panels or on a wall in the application mounting, such that said padding (26) acts as a joint in the attachments determined by a good finish of the concrete in the formworks.

The construction of a building with the described means using the system of the invention is carried out according to the following operating process:

First the necessary foundation is built in the construction site in a conventional manner, installing on the foundation the supporting structure (1) such that the space of the construction is comprised therein, the construction of the building being done floor by floor with the means incorporated in said supporting structure (1), such that the construction of each floor serves as a support for the next floor, the means of the supporting structure (1) moving up to the operating height for the construction of each floor, such that the movement of the pieces of the construction is carried out with minimal lifting displacement.

For the construction of each floor of the building, the double walls (7) necessary for the exterior enclosure of the floor are made in the molding table (6), carrying said walls (7) by means of the gantry crane (10) to their placement position site, forming with them the enclosure of the contour of the floor in construction.

As can be observed in FIG. 5, the building of the mentioned double walls (7) is done in molds (27), in which there are arranged metal framework (28) intended for providing structural strength to the mentioned walls (7), and lances (29) for the connection of these walls (7) with the space dividing partitions in the floor, as well as the pipes (30) necessary for the installations that must be included in the walls (7), a layer of concrete (7.1) being incorporated with respect to the assembly thus arranged at the bottom of the mold (27) and another layer of concrete (7.2) in the upper part, on an insulating material plate (31).

Exterior covering plates (32) can be arranged on the upper layer of concrete (7.2) by means of hardware (33) embedded in said layer of concrete (7.2), whereby the walls (7) are completely finished with a ventilated façade covering.

On the other hand, floor platforms (9) corresponding with the dividing spaces provided in the floor are built on the molding table (8), said platforms (9) being carried in turn with the gantry crane (10) to the placement sites corresponding with the dividing spaces for which they are intended, where they are supported on the partitions and/or walls of the floor constructed at the previous height level.

As depicted in FIG. 6, said floor platforms (9) include lugs (34) for the fitting of the formwork panels (14) by means of their lower holes (23), and threaded bushings (35) for securing said formwork panels (14) by means of their lower pneumatic screw spindles (15).

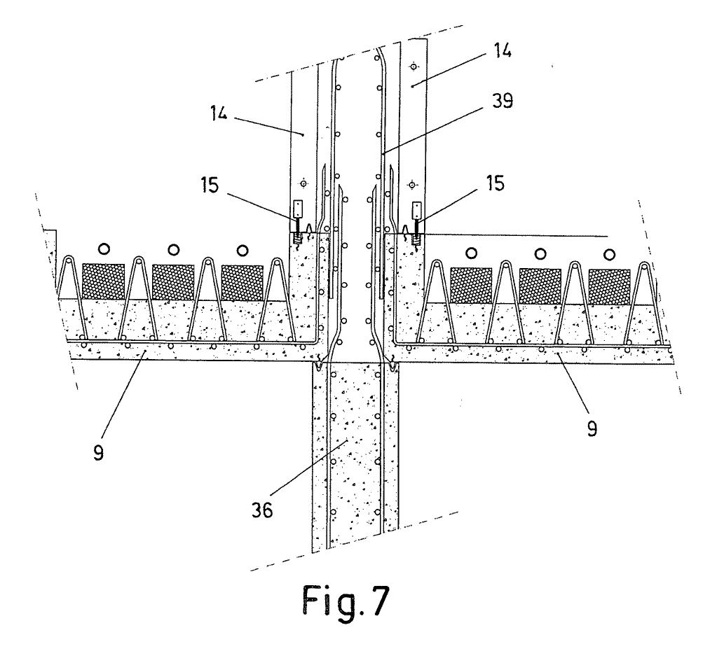

Once the exterior enclosure of the contour has been built by means of the double walls (7) and the floor platforms (9) have been placed in the sites of the dividing spaces to be made in the floor, the formwork panels (14) intended for building the space dividing partitions (36) are vertically arranged on said floor platforms (9), said formwork panels being fitted in the lugs (34) and lashed in the bushings (35), as observed in FIG. 7, building between two panels (14) the formwork for building each of the dividing partitions, on the floor platforms (9) corresponding to the adjacent spaces. The panels (14) of the adjacent formworks are in turn lashed to one another, such that a rigidly secured formwork is built in the entire floor for all the dividing partitions (36) to be built.

The reinforcing framework (39) for the concrete pouring of the partitions (36) are placed in the space comprised between the panels (14) of each formwork, the pipes for the electrical, plumbing and telephone installations, etc. which are provided also being placed in said spaces, and then, by means of supply from the impeller pumps (11), the openings of the formworks formed by the panels (14), as well as the inner opening of the double walls (7) of the outer contour are filled with concrete, whereby forming a rigidly secured assembly between the enclosure of the contour and the interior dividing partitions (36) in the entire building of the floor, the latter thus being completely finished in its construction, to build thereon another floor or the roof of the building, whichever is appropriate.

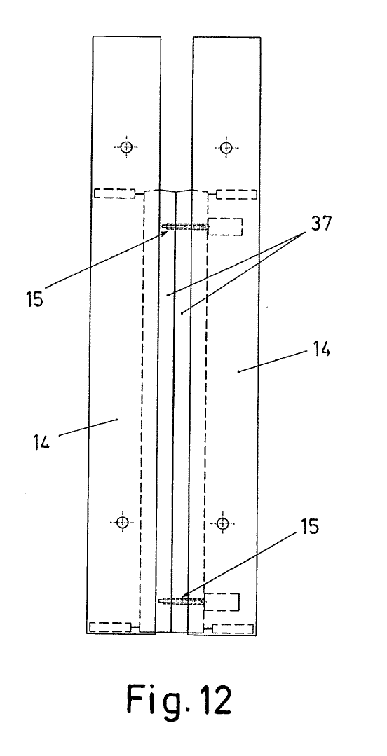

The formwork panels (14) are provided with mobile parts (37) which can be displaced to a front projecting position such that a male form can be determined in the formwork between the corresponding parts (37) of the formwork panels (14) that are arranged facing one another when building the formworks, as shown in FIG. 12, for defining the door and/or window openings in the corresponding dividing partitions (36), such that said openings are also made directly in the constructive building of the floor by means of the formworks.

The entire functional assembly of the system can be computer-controlled, such that minimal operating and manual collaboration is required, and the process of the construction is very fast and with the quality of an automated implementation with complete precision of the development of the operations according to a programming calculated according to suitability.

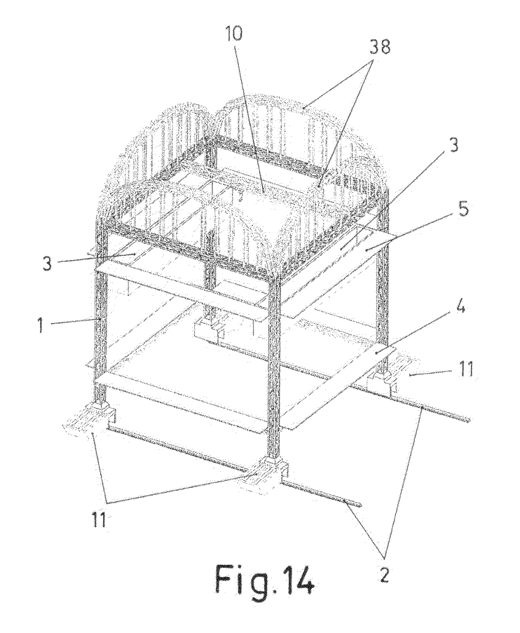

The supporting structure (1) can vary in shape and size according to the buildings to be built, and can incorporate in the upper part reinforcements (38), as depicted in FIG. 14, for increasing its strength and safety, whereas in the upper part and in the entire lateral contour coverings can be arranged for determining an enclosure in which it is possible to work in suitable conditions regardless of the atmospheric conditions which is the cause of losing a great deal of time in conventional constructions.

1-8. (canceled)

9. An automatic system for construction of buildings, wherein a supporting structure (1) mounted on displacement rails (2) is used, covering a space holding the building to be made, in which supporting structure (1) a gantry crane (10) is arranged at the top, whereas operating platforms (4, 5) and stores (3) for housing the elements to be used in the construction are incorporated in vertical displacement mode in the gantry crane, there being arranged in the lower part pumps (11) for impelling the concrete through ducts (12) included in the structure (1) itself to the corresponding construction height, such that the complete construction of each floor in a rigidly secured assembly is carried out with the means incorporated in the mentioned supporting structure (1), the interior dividing partitions (36) being built by concrete pouring by means of formworks built in the site itself with formwork panels (14), incorporating a molding table (6) for building double walls (7) intended for the enclosure of the outer contour in the construction of each floor of the building, characterized in that the formwork panels (14) which are used to build the dividing partitions (36) consist of a metal box with insulating material filler, including therein pneumatic screw spindles (15) to establish the lashings in the application assembly, a heat accumulation block (17) for maintaining a suitable temperature (about 37° C.) for the setting of the concrete in the application formworks, and a vibrating mechanism (19) to facilitate stripping, said formwork panels (14) being complemented with end padding (26) serving as joints in the formworks.

10. The automatic system for construction of buildings according to claim 9, characterized in that the formwork panels (14) include mobile parts (37) that can be positioned so as to project towards the front by means of which male formations are determined in the formworks to build the door and/or window spaces in the concrete pouring for the construction of the dividing partitions (36).

11. The automatic system for construction of buildings according to claim 9, characterized in that incorporated in the floor or in the lower mobile platform (4) arranged in the supporting structure (1) there is a molding table (8) for building floor platforms (9) for each of the dividing spaces of the floor being constructed, lugs (34) being incorporated in said floor platforms (9) for the position fitting of the formwork panels (14) of the dividing partitions (36), and threaded bushings (35) for lashing said formwork panels (14).
